(19) United States
(12) Patent Application Publication
(10) Pub. No.: US 2007/0100958 A1
(43) Pub. Date: May 3, 2007

(54) Method for selecting a functional domain name server

(76) Inventors: Nikhil Hegde, Austin, TX (US); Rashmi Narasimhan, Austin, TX (US); Alexander Medvedev, Austin, TX (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/260,600

(22) Filed: Oct. 27, 2005

(51) Int. Cl. G06F 15/16

(52) U.S. Cl. 709/217

(57) ABSTRACT

A method of choosing a domain name server to resolve a name resolution request includes receiving a name resolution request and associating at least one domain name server listed in a domain name server table with a timestamp. The method further includes accessing a domain name server from the domain name server table based on the timestamp. A system including means for accomplishing similar actions is also disclosed.

### FIELD OF INVENTION

The present invention generally relates to resolving server requests. More specifically, the invention relates to resolving domain name server requests.

### BACKGROUND OF THE INVENTION

Computers communicate over a network by sending and receiving messages addressed to or from particular addresses, such as an IP address. IP addresses are typically a series of numbers that may be difficult for a human to remember, for example 10.10.10.1. Therefore, each IP address is typically associated with a domain name that is easier to remember, such as www.ibm.com. In order to associate the domain name with an IP address, a domain name server is utilized to correlate a domain name with an IP address.

Many computer systems include a domain name server table (“DNS table”) that sequentially lists a number of potentially available domain name servers (“DNS”) that can receive a domain name server request (“DNS request”) for an IP address associated with a user-entered domain name. Many DNS tables include more than one DNS entry. In the event that a particular DNS is unable to communicate or respond, the requesting computer may be delayed in obtaining the requested IP address, and thus, any content associated with the requested IP address.

Currently, a requesting computer waits for a failure of a DNS request via a time-out to attempt to resolve a DNS request with the next DNS from the DNS table. Time-outs can be set as long as 75 seconds. Such lengthy time-outs can yield an unacceptable delay for some users.

The domain name server table is often maintained in a configuration file. For example, the domain name server table includes 4 servers listed in one format. If the first three servers are down, then the name resolution will wait for the requests to the first three servers to timeout before attempting to contact the fourth server, as will each subsequent request until at least one of the first three servers comes back on-line. A time out delay on a first request after the server goes off-line is inevitable, since the requesting server remains unaware of a potential delay, and the order of servers is often determined based on the server load capacity and/or average response time.

It is therefore a challenge to develop a method to facilitate DNS selection to overcome these, and other, disadvantages.

### SUMMARY OF THE INVENTION

A first embodiment of the present invention is a method of choosing a domain name server to resolve a domain name request. The method includes receiving a name resolution request and associating at least one domain name server listed in a domain name server table with a timestamp. The method further includes accessing a domain name server from the domain name server table based on the timestamp.

A second embodiment of the present invention is a computer usable medium including computer readable code for choosing a domain name server to resolve a remote computer name that includes computer readable code for receiving a name resolution request and computer readable code for associating at least one domain name server listed in a domain name server table with a timestamp. The medium further includes computer readable code for accessing a domain name server from the domain name server table based on the timestamp.

A third embodiment of the present invention is a system for selecting a domain name server to contact for a name resolution request that includes means for receiving a name resolution request and means for associating at least one domain name server listed in a domain name server table with a timestamp. The system further includes means for accessing a domain name server from the domain name server table based on the timestamp.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 illustrates one embodiment of a method to choose a domain name server in accordance with one aspect of the invention;

FIG. 2 illustrates another embodiment of a method to choose a domain name server in accordance with one aspect of the invention;

FIG. 3 illustrates another embodiment of a method to choose a domain name server in accordance with one aspect of the invention;

FIG. 4 illustrates another embodiment of a method choose a domain name server in accordance with one aspect of the invention;

FIG. 5 illustrates another embodiment of a method to choose a domain name server in accordance with one aspect of the invention;

FIG. 6 illustrates another embodiment of a method to choose a domain name server in accordance with one aspect of the invention;

FIG. 7 illustrates one embodiment of a system for resolving a domain name server in accordance with one aspect of the invention; and

FIG. 8 illustrates another embodiment of a method for choosing a domain name server in accordance with another aspect of the invention.

### DETAILED DESCRIPTION OF THE PRESENT INVENTION

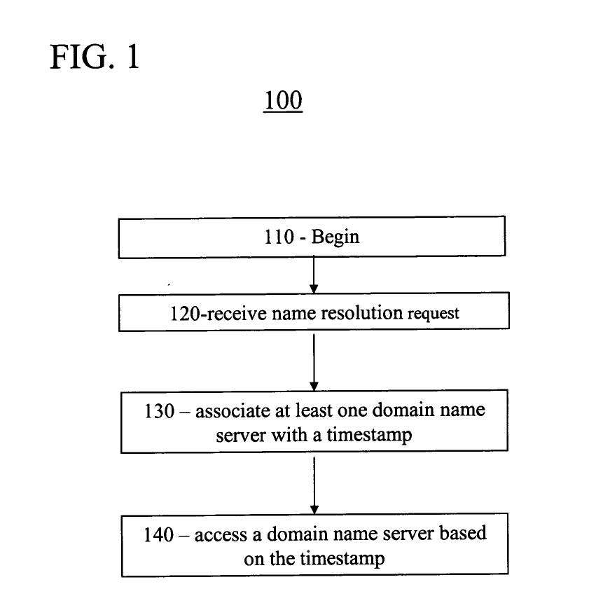

FIG. 1 illustrates one embodiment of a method 100 for choosing a domain name server to resolve a name resolution request in accordance with one aspect of the invention. Method 100 begins at step 10. Any of the inventive methods disclosed herein may be performed in any order, and the order in which the method steps are described does not limit the order in which the steps can be performed.

Method 100 continues at step 120 by receiving a name resolution request. In one embodiment, the request is received at a server that interfaces between a local network and a public network, such as the Internet. In another embodiment, the name resolution request is received at a personal computer with a direct connection to a network. A DNS request is a request sent to the domain name server identifying a remote computer, wherein the identified remote computer is identified by a colloquial name, rather than an IP address. A DNS request is also termed a DNS resolution request.

At least one domain name server is associated with a timestamp at step 130. A timestamp, in one embodiment, represents the earliest time that contact to an associated server will be attempted. For example, the time may be specified by a UNIX® system. In another embodiment, a timestamp is an increasing or decreasing timer that tracks elapsed time after or until a particular time. In one embodiment, a timestamp tracks elapsed time for one hour. In one embodiment, the time as specified by a UNIX® system is determined with the gettimeofday() command, as known to those of skill in the art.

The association between domain name servers and timestamps is implemented, in one embodiment, using a DNS table. An exemplary DNS table is illustrated in Table 1 below, wherein the current time is prior to the time as specified by a UNIX® system as 1091339493.

TABLE 1
Exemplary DNS Table

| Domain Name Server | TIMESTAMP |
|---|---|
| 10.10.10.1 | 1091339504 |
| 10.10.10.2 | 1091339493 |
| 10.10.10.3 | 0 |
| 10.10.10.4 | 0 |

As shown in Table 1, an exemplary DNS table includes a plurality of domain name servers, here listed by IP address, and a timestamp associated with each domain name server. In Table 1, the timestamp is listed with a time as specified by a UNIX® system. The timestamp can be zero, or the timestamp can be a nonzero value.

Table 1 illustrates 4 servers, named 1, 2, 3, and 4 based on the trailing digit of their IP address. In Table 1, server 1 is preferred to server 2, server 2 to server 3, and server 3 to server 4 based on the order of listing. In accordance with the invention,

In one embodiment, a zero timestamp indicates that the computer receiving the name resolution request is not currently aware of any communications delays between the receiving computer and the domain name server associated with the zero timestamp. In one embodiment, the DNS table is maintained in a configuration file (“config file”), and maintained at a secure location. In one embodiment, the DNS table is maintained at /tmp/.current_servers.

Conversely, a non-zero timestamp indicates that the computer receiving the DNS request is currently aware of a communications delay, and that that receiving computer will not attempt name resolution with the server associated with the non-zero timestamp until the non-zero timestamp has a zero value.

The receiving computer chooses a domain name server based on the timestamp at step 140. In one embodiment, choosing a domain name server based on the timestamp includes accessing the DNS table, and accessing the first DNS listed that is associated with a zero timestamp.

As shown in Table 1, a prior attempt to access domain name server “1” timed out, and a prior attempt to access domain name server “2” had also timed out. Domain name servers “3” and “4” have not yet timed out in response to a request. Thus, domain name servers “1” and “2” have been assigned a nonzero timestamp, while domain name servers “3” and “4” have zero timestamps, such that a request made while the table illustrated in Table 1 is current will attempt to contact domain name server “3” without attempting to contact domain name servers “1” and “2”.

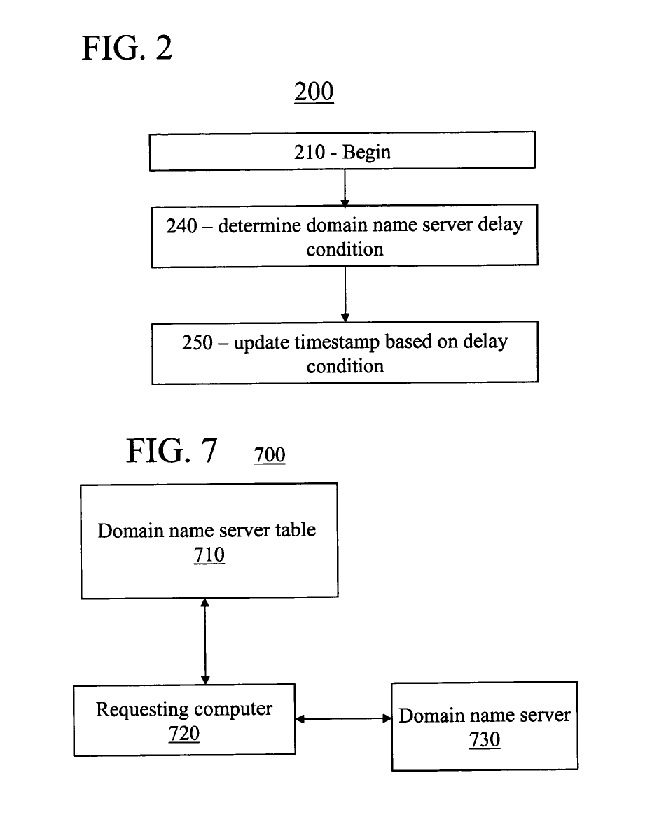

FIG. 2 illustrates another embodiment of a method 200 for associating a domain name server with a timestamp in accordance with one aspect of the invention. Method 200 begins at 210. Method 200 continues by associating a domain name server with a timestamp at step 230. In one embodiment, step 230 is implemented as step 130.

Method 200 determines a domain name server delay condition at step 240. Determining a domain name server delay condition, in one embodiment, comprises receiving a failure notice from a domain name server. In another embodiment, determining the domain name server delay condition comprises failing to receive a response from the domain name server within a specified period of time, termed a ‘time-out’ failure. In yet another embodiment, a ‘ping’ request is issued to the domain name server prior to issuing a name resolution request, and the domain name server delay condition is determined in response to ping results. In one embodiment, the time between issuing a request to the DNS and receiving a response (“request time”) is tracked and stored in a memory in communication with the computer that issues the name resolution request.

In one embodiment, the domain name server delay condition is determined in response to an actual request for name resolution. In another embodiment, the domain name server delay condition is determined on a predetermined interval without a name resolution request. For example, in embodiments that preemptively determine a domain name server delay condition, the computer substantially continuously updates the DNS timestamps. For example, the computer may ping each server on the DNS table every minute, every hour, every day, or other set interval. In another example, the computer may ping each server on the DNS table with a frequency based on the ratio of servers with a nonzero timestamp to the servers with a zero timestamp. In other embodiments, only the first DNS with a zero timestamp receives a ping request.

Based on the domain name server delay condition, the timestamp associated with that domain name server is updated at step 250. Updating the timestamp, in one embodiment, involves changing a zero timestamp to a non-zero value. In one embodiment, updating the timestamp involves changing the timestamp to a value that is determined based on the request time. In another embodiment, updating the timestamp comprises determining a current time and adding a predetermined time to determine the timestamp time. For example, the predetermined time can be one hour, one day, or any appropriate time. In one embodiment, the predetermined time is based on the number of DNS on the DNS list. In another embodiment, the predetermined time is based on the number of DNS that are associated with a non-zero timestamp. In another embodiment, the time is dynamically determined based on factors including round-trip time, such as a ping response time, or a probability of getting no response.

In yet another embodiment, the time is dynamically determined and is adjusted in response to the proportion of DNS associated with a nonzero timestamp to the number of DNS with a zero timestamp, or vice versa. In another embodiment, the timestamp of another DNS is adjusted in response to the proportion of DNS associated with a nonzero timestamp to the number of DNS with a zero timestamp, or vice versa.

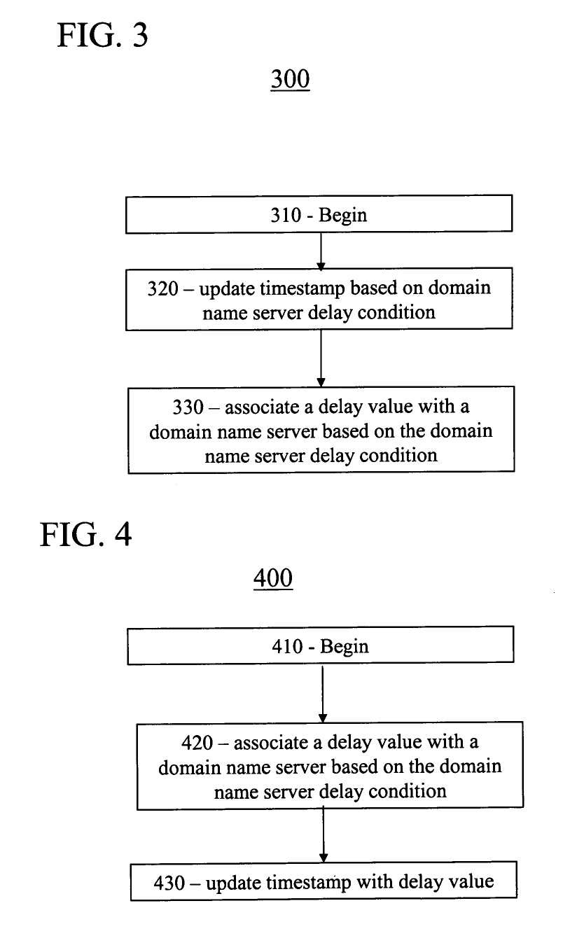

FIG. 3 illustrates one embodiment of a method 300 for updating the timestamp based on the domain name server delay condition, in accordance with one aspect of the invention. Method 300 begins at step 310. At step 320, the timestamp is updated based on the domain name server delay condition. In one embodiment, step 320 is implemented as in step 250.

Method 300 associates a delay value with a domain name server based on the domain name server delay condition at step 330. In one embodiment, the timestamp is updated with the request time, or a time value derived from the request time.

FIG. 4 illustrates one embodiment of a method 400 for updating a timestamp, in accordance with one aspect of the invention. Method 400 begins at 410. Method 400 then associates a delay value with a domain name server based on the domain name server delay condition at step 420.

At step 430, the timestamp is updated with the delay value. The update can be a fixed, predetermined time period, or a dynamically determined value. A dynamically determined value can be based on a number of factors, including round-trip time to server and historical success of name resolution requests to that server. In another embodiment, the probability of getting no response from the server serves as a basis for the delay value.

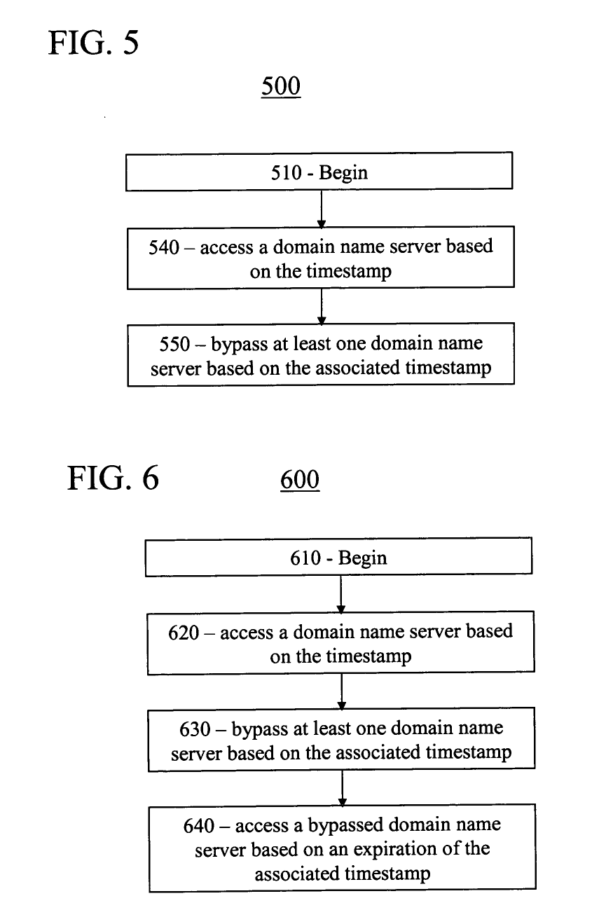

FIG. 5 illustrates one embodiment of a method 500 for choosing a domain name server based on the timestamp, in accordance with one aspect of the invention. Method 500 begins at step 510.

At step 520, a domain name server is accessed based on the timestamp. In one embodiment, step 520 is implemented as in step 140.

At least one domain name server is bypassed based on the associated timestamp at step 530. In one embodiment, bypassing at least one domain name server includes not requesting name resolution from a DNS based on an associated non-zero timestamp. For example, as illustrated in Table 1, above, bypassing a domain name server, for example, would result in not requesting name resolution from 10.10.10.1 and 10.10.10.2, and requesting name resolution from 10.10.10.3.

FIG. 6 illustrates one embodiment of a method 600 for choosing a domain name server based on the timestamp, in accordance with one aspect of the invention. Method 600 begins at step 610.

A domain name server is accessed based on the timestamp at step 620. In one embodiment, step 620 is implemented as step 140.

At least one domain name server is bypassed based on the associated timestamp at step 630. In one embodiment, step 630 is implemented as step 530.

A bypassed domain name server is accessed based on an expiration of the associated timestamp at step 640. In one embodiment, expiration of the associated timestamp is determined by comparing the current time with the timestamp to determine if the timestamp is prior or earlier in time than the timestamp. Current time is determined using any appropriate method, such as a gettimeofday( ) query. In one embodiment, the timestamp is replaced with a zero value based on a determination that the timestamp has expired.

FIG. 7 illustrates one embodiment of a system 700 for choosing a domain name server, in accordance with one aspect of the invention. System 700 includes requesting computer 720, DNS table 710 and domain name server 730. As shown in FIG. 7, requesting computer 720 is in communication with DNS table 710 to determine an IP address of a domain name server to contact with a request for DNS resolution. Further, requesting computer 720 is able to communicate with domain name server 730 to resolve a name resolution request.

DNS table 710 can be hosted and maintained at the same, or different, location as the requesting computer 720. Requesting computer 720 can be implemented as a server or a personal computer connected to a network such as the Internet. Communications between requesting computer 720 and DNS table 710 can be formatted with any appropriate communications protocol. Similarly, communications between requesting computer 720 and domain name server 730 can be formatted with any appropriate communications protocol. An appropriate communications protocol includes, but is not limited to, an Internet protocol.

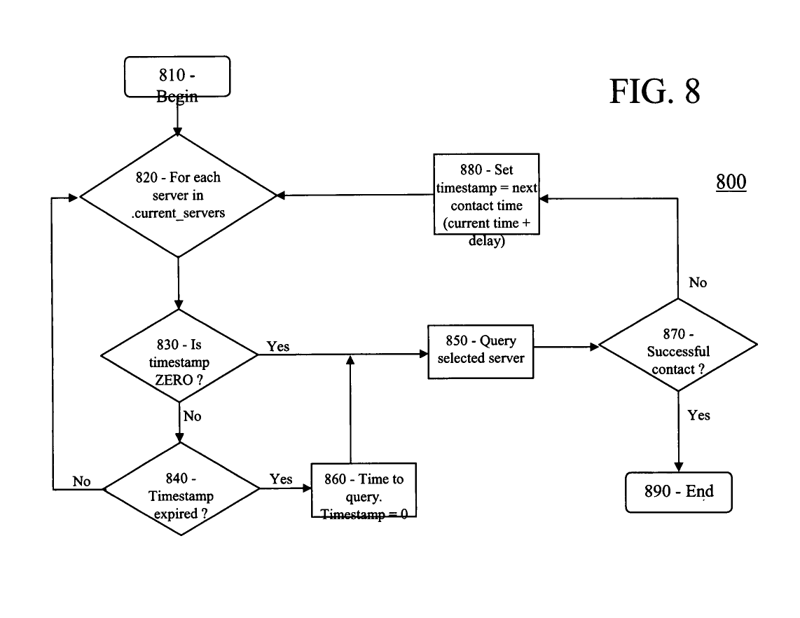

FIG. 8 illustrates another method 800 to choose a domain name server in accordance with another aspect of the invention. Method 800 begins at 810.

Method 800 executes a FOR loop at steps 820, 830, and 840. Method 800 determines, for each server in the DNS list (i.e. at /.current_servers) (step 820), whether the timestamp associated with that server is zero (step 830), and whether the timestamp is expired (step 840).

In response to a determination that the timestamp is zero at step 830, method 800 queries the selected DNS for resolution of a remote computer name at step 850. In response to a determination that the timestamp is non-zero at step 830, method 800 determines if the timestamp is expired at step 840, and if the timestamp has expired, sets the timestamp to zero at step 860, prior to querying the selected DNS at step 850. In the event that the timestamp has not expired, method 800 returns to step 820 and iterates again.

After querying the selected server at step 850, method 800 determines if the query was successful at step 870. Based on a successful query, method 800 ends at step 890. In the event that the query was unsuccessful, method 800 sets the timestamp for the queried server to the next contact time at step 880, and iterates to step 820. Setting a timestamp, in one embodiment, is implemented as in methods 200, 300, or 400, alternatively. In another embodiment, the timestamp is set as the current time plus a delay value. The delay value can be implemented as a static determination or a dynamic determination based on the number of domain name servers on the DNS table or the number of domain name servers on the DNS table that have a zero or non-zero timestamp.

Exemplary implementations of computer code implementing an algorithm to choose a domain name server from a DNS table are as follows. These algorithms are merely exemplary, and the invention is not limited to these coding examples.

### EXAMPLE ONE

| | |
|---|---|
| NAME: | WhichServerToUse |
| INPUT: | ServerList |
| OUTPUT: | Server to query |

| | |
|---|---|
| CONSTANTS: | ServerTimeout [ServerID], |

TempFile (/tmp/.current_servers)

START WhichServerToUse
For each entry in TempFile

if timestamp is non-zero

/* This server was down. Check
if it is time to use this server*/
if current_time > = timestamp

/* It is time to query server */
/*Change timestamp in TempFile
so non one else will attempt

same server*/

edit TempFile and add timestamp
next to server, where, timestamp

= current_time + ServerTimeout[server]

return server address

else

continue to next server in list

endif

else

/*timestamp is zero, server is up*/
return server address

endif

endfor
END WhichServerToUse

### EXAMPLE TWO

| | |
|---|---|
| NAME: | ServerList |
| INPUT: | ServerList |
| OUTPUT: | Server to query |

| CONSTANTS: | ServerTimeout [ServerID], TempFile |
|---|---|
| | (/tmp/.current_servers) |

START ProcessRequest

Find Server using WhichServerToUse

SEND: Send request to server

if no response

edit TempFile and add timestamp next to server

where, timestamp=current_time +ServerTimeout[server]

find next server using WhichServerToUse
Goto SEND

else

edit TempFile and add timestamp of ZERO next to server
return response from server

endif

END ProcessRequest

UNIX® is a registered trademark of The Open Group in the United States and other countries.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method of choosing a domain name server to resolve a domain name server request comprising;
receiving a name resolution request;
associating at least one domain name server listed in a domain name server table with a timestamp; and
accessing a domain name server from the domain name server table based on the timestamp.

2. The method of claim 1 wherein associating at least one domain name server listed in a domain name server table with a timestamp comprises:
determining a domain name server delay condition; and
updating the timestamp associated with the domain name server associated with the domain name server delay condition.

3. The method of claim 2 further comprising associating a delay value with a domain name server based on the domain name server delay condition.

4. The method of claim 3 wherein updating the timestamp comprises updating the timestamp with the delay value.

5. The method of claim 2 wherein the timestamp is set at a nonzero value in response to a domain name server delay condition.

6. The method of claim 2 further comprising predicting a downtime based on the domain name server delay condition, wherein the timestamp is associated with a predicted downtime.

7. The method of claim 1 wherein accessing a domain name server comprises bypassing at least one domain name server from the domain name server table based on the associated timestamp.

8. The method of claim 7 further comprising accessing a bypassed domain name server based on an expiration of the associated timestamp.

9. The method of claim 8 wherein the predicted downtime is estimated in response to a factor selected from the group consisting of a round-trip time, probability of a response, a comparison of round-trip times across at least two domain name servers.

10. A computer usable medium including computer readable code for choosing a domain name server to resolve a domain name server request comprising;
computer readable code for receiving a name resolution request;
computer readable code for associating at least one domain name server listed in a domain name server table with a timestamp; and
computer readable code for accessing a domain name server from the domain name server table based on the timestamp.

11. The medium of claim 10 further comprising
computer readable code for determining a domain name server delay condition; and
computer readable code for updating the timestamp associated with the domain name server associated with the domain name server delay condition.

12. The medium of claim 11 further comprising computer readable code for associating a delay value with a domain name server based on the domain name server delay condition.

13. The medium of claim 12 wherein computer readable code for updating the timestamp comprises computer readable code for updating the timestamp with the delay value.

14. The medium of claim 11 wherein the timestamp is set at a nonzero value in response to a domain name server delay condition.

15. The medium of claim 10 wherein computer readable code for accessing a domain name server comprises computer readable code for bypassing at least one domain name server from the domain name server table based on the associated timestamp.

16. The medium of claim 15 further comprising computer readable code for accessing a bypassed domain name server based on an expiration of the associated timestamp.

17. The medium of claim 10 wherein the timestamp is associated with a predicted downtime.

18. The medium of claim 17 wherein the predicted downtime is estimated in response to a factor selected from the group consisting of a round-trip time, probability of a response, a comparison of round-trip times across at least two domain name servers.

19. A system for choosing a domain name server to resolve a domain name server request comprising;
means for receiving a name resolution request;
associating at least one domain name server listed in a domain name server table with a timestamp; and
accessing a domain name server from the domain name server table based on the timestamp.

20. The system of claim 19 further comprising
means for determining a domain name server delay condition; and
means for updating the timestamp associated with the domain name server associated with the domain name server delay condition.
